(19) United States
(12) Patent Application Publication
(10) Pub. No.: US 2025/0135520 A1
(43) Pub. Date: May 1, 2025

(54) FACILITY AND METHOD FOR TREATING THE SURFACE OF AN ELONGATE PRODUCT FOR THE PURPOSE OF WIRE-DRAWING

(71) Applicant: APERAM, Luxembourg (LU)

(72) Inventors: Ismaël Romaric Alexis GUILLOTTE, Verquin (FR); Baptiste Pierre Jean LATOUCHE, Lille (FR)

(21) Appl. No.: 18/836,634

(22) PCT Filed: Feb. 11, 2022
(86) PCT No.: PCT/IB2022/051241

§ 371 Date: Aug. 7, 2024

(51) Int. Cl. B21C 43/04; B21C 9/00; B23K 26/08; B23K 26/36

(52) U.S. Cl. CPC B21C 43/04; B21C 9/00; B23K 26/083; B23K 26/36

(57) ABSTRACT

The invention relates to a facility for treating a moving long product made of metal having a surface coated with a layer of oxide, comprising a stripping assembly comprising a group of lasers that are distributed around the long product a control unit for acquiring information relating to the long product the control unit being configured to determine operating parameters to be dictated on the stripping assembly in order to strip of the layer of oxide and to ablate a layer of metal of predetermined thickness, and so to obtain a predetermined roughness at the long product by comparing same with the experimental results pre-recorded in the control unit and dictating the operating parameters to the stripping assembly.

The present invention relates to a facility and a method for treating the surface of a long product for the purpose of wire-drawing same, after the latter has undergone exposure to an oxidizing atmosphere for some of the chemical elements thereof, e.g. during a residence time in a heat treatment furnace.

Hereinafter in the text, the field of stainless-steel wires and ribbons of all categories (austenitic, ferritic, austeno-ferritic, etc.) will be taken as a privileged example of application of the invention. However, it should be understood that the above is not limiting, and that the invention can be applied to other metals for which there are technical problems similar to the problems encountered on stainless-steel wires and ribbons, and in particular to the various classes of carbon steels and special alloys, in particular ferrous alloys.

Such long products are usually produced by a series of treatments including heating a semi-finished product (in particular a billet), hot rolling to produce the long product, winding the long product into a crown which is then annealed, in a furnace under a reducing atmosphere or in a gas furnace under an oxidizing atmosphere.

The long product thereby obtained is intended to be subjected to a drawing treatment using a wire-drawing die in order to improve the dimensional accuracy and the mechanical properties of the long product.

The sequence of treatments carried out before the wire-drawing, more particularly hot rolling and annealing, if not carried out under a fully reducing or inert atmosphere, leads to the formation of a layer of oxide on the surface of the long product. The oxides have a composition which varies substantially depending on the composition of the base metal and the conditions of formation thereof. Most usually, the oxides of the elements Fe, Cr, Mn and Si in the case of stainless-steels, but also of the elements Ni, Nb and Cu if the grade containing said elements, are predominant.

Such undesirable oxides should be removed before the wire drawing, in particular to prevent same from becoming embedded in the surface of the long product during the wire drawing and resulting in a poor surface finish.

It should be understood that the layer of undesirable oxides referred to herein is not the thin layer based on Cr oxides (so-called “passive layer”) which forms spontaneously in air and at ambient temperature on the surface of stainless-steels, and which protects same from oxidation. The layer of oxides that causes a problem, and that we want to eliminate, is the layer that forms during residence times of the product at high temperature in an oxidizing atmosphere. Once such layer has been removed, the surface of the stainless-steel is exposed and the protective passive layer of Cr oxides can be formed again, quickly and spontaneously, making the steel stainless again under normal conditions of use.

Moreover, before the wire drawing is carried out, long products require a step of surface preparation intended to adjust the surface roughness of the products. The adjustment of the roughness provides good adhesion of the soaps deposited on the surface of the long product just before the wire drawing thereof, thus to facilitate the wire drawing.

Conventionally, the layer of undesirable oxides is removed by means of a chemical or electrolytic stripping method, or a succession of such strippings.

Chemical stripping is carried out in one or a plurality of baths of hydrofluoric acid, hydrochloric acid, sulfuric acid or nitric acid. Electrolytic stripping is typically carried out in a bath of sodium sulfate or a (nitric or sulfuric) acid bath.

Chemical stripping is the most radical method for removing undesirable oxides. The stripping is carried out on the long product in the form of crowns, or in movement. Chemical stripping is also used to modify the surface roughness of the long product so as to make the product easier to be wire drawn.

But chemical stripping has many drawbacks.

In particular, chemical stripping consumes high quantities of acids, with, in addition, very little possibility of recovering part of the acids for a subsequent use.

The infrastructures needed for the execution thereof, namely the successive stripping baths and the accessories thereof, are expensive and bulky.

Such facilities use hazardous products, more particularly hydrofluoric acid. The liquid and solid pollutant discharges (sludge containing oxides mixed with stripping liquids) thereof have to be stored and retreated according to strict regulations the severity of which will only increase in the future, which is costly. Heated acid baths also release acid vapors that have to be neutralized. Nitric acid is also a source of NOx releases that have to be captured and treated.

The presence of hexavalent chromium in solution in stripping liquids also represents a high risk to the health of the personnel and for the environment: the concentrations thereof in the liquids and exposure of the personnel are measured and monitored.

Moreover, stripping times can be very long, on the order of several tens of minutes for steel grades with high corrosion resistance.

The stripping of long products in the form of a crown reduces the size of stripping facilities but can lead to non-uniform stripping of the product. Indeed, the covering of the coils and the links holding the crown can prevent the stripping products from reaching certain regions of the product, and the most central coils are less exposed to the stripping products than the outer coils.

Possibilities were thus examined for replacing, at least in some cases, the chemical or electrolytic stripping of long products by methods using a laser.

In particular, documents CN 210816759 U, CN 210647767 U, CN 108405652 A and KR 101735006 B1 describe facilities for stripping moving metal wires by means of a plurality of lasers distributed around the metal wire. More particularly, lasers are arranged regularly around the circumference of a circle the center of which is occupied by the wire to be treated.

Such solution is not entirely satisfactory. Indeed, the solution alone does not provide a complete stripping of the layer of oxides. Furthermore, replacing chemical stripping by laser treatment does not make it possible to solve the problem of wire roughness, and the stripping solution proposed by said documents provides a wire the roughness of which is not necessarily suited to wire drawing. The roughness could then be adjusted by chemical stripping, but in such a case the problems associated with chemical stripping, as mentioned hereinabove, would not be solved.

An aim of the invention is thus to propose a facility and a method for the treatment of a metal long product which provides a long product suitable for wire drawing without any additional operation, and which makes it possible to dispense with the aforementioned drawbacks of chemical stripping.

To this end, the subject matter of the invention is a facility for the treatment of a running metal long product in movement, in preparation for a wire drawing step, the long product having at least one surface covered with a layer of oxides, characterized in that same comprises:
a stripping assembly comprising at least one group of a plurality of lasers distributed around the moving long product, each laser being configured to emit beams onto the surface of the moving long product for stripping the surface, each laser being intended for the treatment of an associated portion of the surface of the long product,
a control unit apt to acquire information relating to the long product in movement, the information comprising a speed of movement of the long product and at least one characteristic dimension of the long product in a plane orthogonal to an axis of movement of the long product,
   the control unit being configured to:
determine the operating parameters to be imposed on the stripping assembly for obtaining the stripping of the layer of oxide on the surface of the long product and to ablate a layer of metal of predetermined thickness on the surface of the long product, and so as to obtain a predetermined roughness on the surface of the long product, compared with experimental results pre-recorded in the control unit, and
impose said operating parameters on said stripping assembly.

According to one embodiment, the lasers of the or each group of lasers are uniformly distributed around the long product in movement.

According to one embodiment, the operating parameters include an emission power of the lasers of the or each group and/or a laser/material interaction time at each point on the surface of the long product.

Preferably, the stripping assembly comprises a distribution system configured to shape the laser beams or move the laser beams across the surface of the long product such that the laser beams emitted by the plurality of lasers in the or each group cover the entire surface of the long product during the movement thereof.

According to one embodiment, the distribution system comprises, for each laser of at least one group, an optical device configured to transform each beam emitted by the associated laser into a band affecting a portion of the surface of the long product.

In a variant, the distribution system comprises, for each laser in at least one group, a scanning device configured to move the beams generated by the associated laser across the surface of the long product with a predetermined scan speed and scan pitch, so that the beams emitted by each laser affect a portion of the surface of the long product.

Preferably, the operating parameters comprise the scan speed and the scan pitch of the scanning device.

According to one embodiment, the surface portion of the long product is delimited by two straight lines of the surface of the long product parallel to the axis of movement.

Preferably, the stripping assembly comprises a first group of a plurality of first lasers distributed around the moving long product and a second group of a plurality of second lasers distributed around the moving long product, each second laser being downstream of each first laser of the first group with respect to the axis of movement.

Generally, the first lasers are configured to etch the layer of oxide on the surface of the long product and ablate a layer of metal of predetermined thickness on the surface of the long product, and the second lasers are configured to impart the predetermined roughness to the surface of the long product.

Preferably, the first lasers are continuous emission lasers, and the second lasers are continuous emission lasers or lasers configured to emit pulsed beams, in particular nanosecond lasers.

A further subject matter of the invention is a method for treating, using a treatment facility according to the invention, a moving metal long product, in preparation for a wire drawing step, the long product having at least one surface covered with a layer of oxides, comprising the following steps:
acquisition by the control unit of information relating to the long product in movement, the information comprising a speed of movement of the long product and at least one characteristic dimension of the long product in a plane transverse to an axis of movement of the long product,
determination by the control unit, according to the information relating to the long product in movement, of the operating parameters to be imposed on the stripping assembly for obtaining the stripping of the layer of oxide on the surface of the long product and to ablate a layer of metal of predetermined thickness on the surface of the long product, and so as to obtain a predetermined roughness on the surface of the long product, by comparison with experimental results pre-recorded in the control unit,
control by the control unit of the stripping assembly to impose said operating parameters on the stripping assembly,
emission by the stripping unit, by means of lasers, of laser beams on the surface of the moving long product according to the operating parameters determined by the control unit.

According to one embodiment, during the emission step, the laser beams are emitted by lasers uniformly distributed around the moving long product.

Preferably, during the emission step, the laser beams are shaped or moved over the surface of the long product by a distribution system of the stripping assembly, controlled by the control unit, in such a way that the laser beams emitted by the plurality of lasers of the or each group cover the entire surface of the long product as same moves.

According to one embodiment, the distribution system comprises, for each laser of at least one group, an optical device, the optical device transforming each beam emitted by the associated laser into a strip affecting a portion of the surface of the long product.

In a variant, the distribution system comprising, for each laser of at least one group, a scanning device, the scanning device moving the beams generated by the associated laser over the surface of the long product, according to a scan speed and a scan pitch determined and controlled by the control unit, so that the beams emitted by each laser affect a portion of surface of the long product.

For example, the scanning device moves the beams along a first direction forming an angle comprised between 0° and 90°, e.g. 45°, with the axis of movement and along a second direction orthogonal to the first direction. The two directions are e.g. orthogonal and parallel, respectively to the axis of movement, or each form a non-zero angle with the axis of movement.

According to one embodiment, the portion of surface of the long product is delimited by two straight lines of the surface of the long product parallel to each other, in particular parallel to the axis of movement.

Preferably, the stripping assembly comprising a first group of a plurality of first lasers distributed around the moving long product and a second group of a plurality of second lasers distributed around the moving long product, each second laser being downstream of each first laser of the first group with respect to the axis of movement, the emission step comprising the emission of laser beams by the lasers of the first group and the lasers of the second group onto the surface of the moving long product.

Generally, the first lasers strip the layer of oxide on the surface of the long product and ablate a layer of metal of predetermined thickness on the surface of the long product, and then the second lasers impart the predetermined roughness to the surface of the long product.

A further subject matter of the invention is a metal long product for wire drawing, the long product having periodic roughness patterns on the surface thereof, the width of the periodic patterns being comprised between 5 μm and 1 mm.

Generally, the width of the periodic patterns is comprised between 5 μm and 200 μm.

According to one embodiment, the periodic patterns consist of periodic striations, comprising a regular alternation of protruding lines and grooves, or of patterns comprising a regular alternation of peaks and recesses along a first and second distinct directions.

Generally, the mean height between the ridges and the grooves, or the mean height between the peaks and the recesses, is comprised between 0.2 μm and 500 μm.

The long product is in particular a wire or a ribbon.

The long product is apt to be drawn without undergoing a surface preparation treatment by chemical or mechanical stripping.

The invention will be better understood upon reading the following description, given as reference to the following enclosed drawings, amongst which:

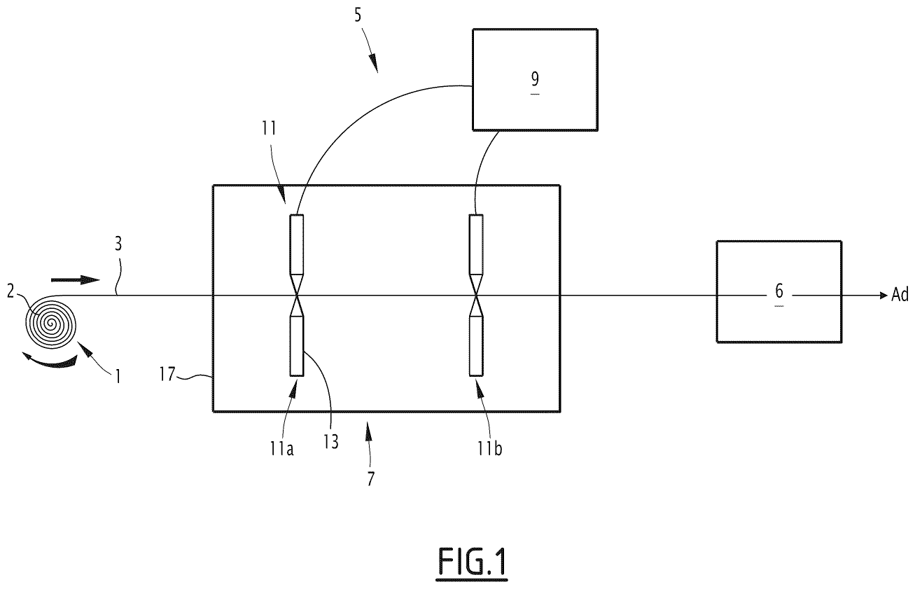

FIG. 1 schematically illustrates, from a profile, a laser stripping facility according to an embodiment of the invention;

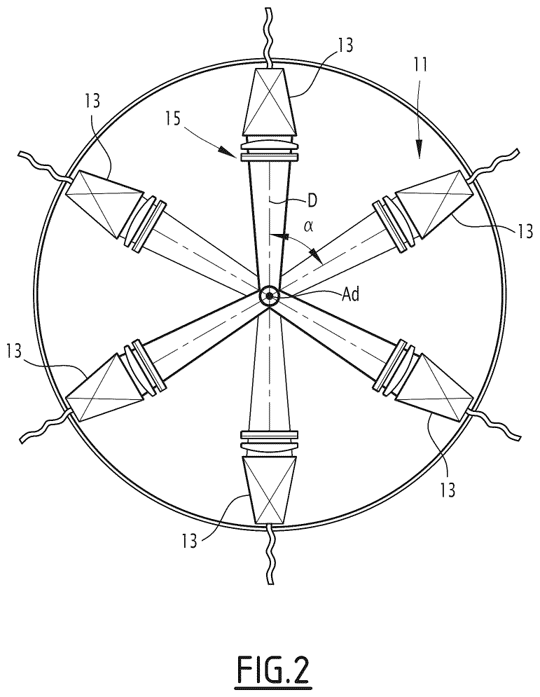

FIG. 2 illustrates an example of the arrangement of lasers around a moving product, according to one embodiment.

The treatment facilities which will be described in detail and illustrated by examples will be essentially described with reference to the treatment of a moving stainless-steel wire, which has just undergone an annealing in the form of a crown.

The treatment facility according to the invention which will be described can also be integrated into a continuous treatment line comprising more equipment or less equipment than that which will be described, or be the subject of a separate facility specially dedicated to such treatment.

Also, the equipment usually present on such lines, which have no major metallurgical role and, in any case, do not intervene as such in the conduct of the treatment carried out according to the invention, have not been shown. Mention may be made in particular of straighteners and wire guides for moving the long product, and accumulators which serve as “buffers” between some of the equipment which may each require a different speed of movement of the product.

The continuous line shown includes firstly a facility 1 for unwinding a crown 2 of a hot-rolled stainless-steel long product 3.

The long product 3 is e.g. a ribbon or a wire.

A ribbon has a width comprised e.g. between 1 and 8 mm and a thickness comprised between 0.1 and 3 mm.

The wire has a diameter comprised e.g. between 1 and 14 mm.

The long product 3, in particular wire or ribbon, has a weight comprised e.g. between 10 kg and 1000 kg.

The long product 3 includes on the surface thereof a layer of oxides with a thickness generally comprised between 0.2 and 30 μm.

The long product 3 is moved at a speed typically up to 15 m/s.

According to the embodiment shown in FIG. 1, the treatment facility 5 is arranged on the line downstream of the unwinding facility 1 and upstream of a wire drawing facility 6. In such embodiment, the unwinding facility 1, the treatment facility 5 and the wire drawing facility 6 are arranged on a continuous line.

The treatment facility 5 includes a stripping assembly 7 and a control unit 9.

The stripping assembly 7 is intended to treat the surface of the long product 3 in order to strip the layer of oxide on the surface of the long product 3, to ablate a layer of metal of predetermined thickness on the surface of the long product 3, and so as to obtain a predetermined roughness at the surface of the long product 3. The stripping assembly 7 is more particularly configured to treat the surface of the long product 3 homogeneously, so that the surface state of the long product 3 is homogeneous over the entire surface.

The stripping assembly 7 is intended to strip the layer of oxide by ablation, sublimation or vaporization of the oxides.

The layer of metal to be ablated is located under the layer of oxide. The ablation of a layer of metal of predetermined thickness on the surface of the long product 3 makes it possible to obtain a surface of better quality at the end of the treatment. Indeed, the metal under the layer of oxide generally contains surface defects, internal oxides, inclusions and/or zones of different chemical composition from the chemical composition of the core of the metal, which should be removed.

The thickness of the layer of metal to be ablated is typically comprised between 5 μm and 50 μm. For example, for a long product made of a nickel alloy 625, the thickness is comprised between 10 μm and 15 μm.

Obtaining a predetermined roughness on the surface of the long product 3 optimizes the adhesion of the soaps used for wire drawing, and thereby leads to improved wire drawing performance.

The desired roughness depends on the composition of the metal, on dimensions thereof and on the desired wire drawing performance.

The roughness is evaluated by measurement along the transverse direction of the long product using a contact probe as per the standard NF EN ISO 4287:1998.

For example, for grades with low roughness (in particular of the type 625), the roughness Ra with a cutoff frequency λc=0.8 mm (or Ra_{0.8}) is less than 1.4 μm.

For grades with a more marked topography or relief (in particular grade 286), the roughness Ra with a cutoff frequency λc=2.5 mm (or Ra₂₅) is less than 6 μm, and generally greater than 1.4 μm.

The stripping assembly 7 comprises at least one group 11 of a plurality of lasers 13 intended to be distributed around the long product 3 during the movement thereof. The lasers are e.g. centered around an axis, hereinafter referred to as the axis of movement A_{d}, intended to correspond to a central axis of the long product during the movement thereof.

Each laser 13 is intended to treat a portion of the surface of the long product 3. In particular, each portion thereby assigned to a given laser 13 is delimited by two straight lines of the surface of the long product parallel to the direction of movement.

Each portion generally extends throughout the length of the long product 3.

In particular, when the long product 3 is a ribbon, the portion assigned to each laser 13 is a strip of predetermined width of the surface of the product (the width then being equal to the distance between the two straight lines delimiting the portion).

When the long product 3 is a wire, the portion assigned to each laser 13 is a portion of the surface of the wire 3 delimited by two straight lines parallel to the direction of movement, the two straight lines forming, with the axis of movement A_{d}, a given angle denoted by βi.

The set of portions assigned to the lasers 13 of the same group 11 covers the entire surface of the product. Thereby, in the case of a wire, the sum of the angles βi is greater than or equal to 360°.

Preferably, the sum of the surface areas of the portions assigned to the lasers 13 of the same group 11 is greater than the surface area of the surface of the long product. In such case, each portion assigned to a laser 13 partially covers the portion assigned to two other lasers 13. It is thereby possible to prevent or minimize the differences in surface state that could exist between the central zone of a portion and the zones located at the periphery thereof, which are likely to receive a laser power lower than the power received by the central zone of a portion. The overlap of one portion by another indeed allows the overlap zones of the two portions concerned, each located at the periphery of the respective portion, to be treated by two lasers 13.

Preferably, the portions assigned to the lasers 13 are of equal dimensions. For example, when the long product 3 is a wire, the angles βᵢ associated with the lasers of the group 11 are equal to each other. For example, since the lasers 13 of the group 11 are regularly distributed around the wire 3, the angles βᵢ associated with the lasers 13 of the group 11 are equal to one another.

In the example illustrated, the stripping assembly 7 comprises two groups: a first group 11a of a plurality of first lasers 13 distributed around the moving long product 3, and a second group 11b of a plurality of second lasers equally distributed around the moving long product 3.

The second lasers of the second group 11b are downstream of the first lasers of the first group 11a with respect to the direction of movement. More particularly, each second laser is arranged downstream of all the first lasers with respect to the direction of movement.

Each group 11 of lasers is intended to treat the surface of the long product.

According to one embodiment, each group 11 of lasers is intended to treat the entire surface of the long product. In such embodiment, the entire surface of the long product is intended to be treated successively by the lasers of the first group 11a, then by the lasers of the second group 11b, and where appropriate, by the lasers of each additional group.

In a variant, at least one group 11 of lasers is intended to treat only part of the surface of the long product. In such variant, the groups 11 of lasers, taken together, are intended to treat the entire surface of the long product.

The or each group 11, 11a, 11b of lasers comprises at least three lasers 13. According to one embodiment, the laser groups comprise an identical number of lasers. In a variant, the number of lasers 13 varies from one group to another.

Each laser 13 is intended to emit laser beams along a main emission direction denoted by D₁, . . . Dᵢ . . . . Dₙ, where n is the number of lasers 13 of a group 11, 11a, 11b.

If the long product 3 is a wire, the main emission directions D₁, . . . Dᵢ . . . . Dₙ are all oriented toward the center of the wire, i.e. the axis of movement A_{d}.

Preferably, within each group 11, 11a, 11b, the lasers 13 are equidistant from the axis of movement A_{d} of the wire 3.

For example, the or each group 11, 11a, 11b of lasers consists of lasers 13 distributed around the circumference of the same circle, the center of which belongs to the axis of movement A_{d}. The main emission directions D₁, . . . Dᵢ . . . . Dₙ are then concurrent and intersect on the axis of movement A_{d}.

In a variant, the lasers 13 of the same group 11, 11a, 11b are not distributed on the circumference of a circle but on the circumference of at least two circles centered on the axis of movement A_{d} or on the circumference of a circular helix, the helix axis of which is the axis of movement A_{d}.

Preferably, the surface areas of the portions of surface intended to be treated by the different lasers 13 of a group 11, 11a, 11b are identical.

According to one embodiment, the surface areas of the portions intended to be treated by each laser 13 of a group are equal from one group to another. In a variant, the areas of the surface portions intended to be treated by each laser 13 of a group vary from one group to another.

The lasers 13 are preferably regularly distributed around the long product.

For example, the lasers are distributed in such a way that the main emission direction of each laser of the group 11, 11a, 11b forms a non-zero angle, called the spacing angle α, with the main emission directions of two other lasers of the group 11, 11a, 11b, the angle α being the same whatever the laser considered within a group 11.

In such case, and in the case of a wire, the angle α is less than or equal to the angle β formed by the two straight lines delimiting the portion assigned to each laser 13 with the axis of movement A_{d}. When the angle α is less than the angle β, the portions partially overlap each other.

In particular, if the number of lasers of the group 11, 11a, 11b is equal to three, the angle α is equal to 120°. If the number of lasers of the group 11, 11a, 11b is equal to six, the angle α is equal to 60°.

According to one embodiment, the spacing angles a are equal from one group to another.

In a variant, the spacing angle α of the lasers of one group 11a, 11b is different from the spacing angle α of the lasers of at least one other group 11b, 11a.

Moreover, according to one embodiment, the lasers 13 of the different groups 11a, 11b are not aligned with each other along a direction parallel to the axis of movement A_{d}. For example, in the case of two groups 11a, 11b, the lasers of the first group 11a are not aligned with the lasers 13 of the second group 11b along a direction parallel to the axis of movement A_{d}. Thereby, the main emission direction of each laser 13 of the first group 11a forms a non-zero angle, called the phase shift angle, with the main emission direction of a laser of the second group 11a 11b, the phase shift angle being smaller than the spacing angle α of the lasers of the first and second groups.

For example, if the spacing angles of the lasers of the first and second groups 11a, 11b are identical, the phase shift angle is equal to half the spacing angle.

Such a phase shift serves to prevent a given zone of the surface of the long product 3 from being situated in the central zone of the portion assigned to a laser 13 of the first group 11a and in the central zone of the portion assigned to a laser 13 of the second group 11b, or vice versa in a peripheral zone of the two portions, and thus to obtain a surface of more homogeneous quality.

In the example illustrated in FIG. 2, the group 11 of lasers comprises six lasers uniformly distributed around a wire 3, and are distributed around the same circle the center of which is the axis of movement A_{d}. The main emission direction Dᵢ of each laser 13 then forms, with the main emission directions Dᵢ₋₁, Dᵢ₊₁ of two other lasers 13 of the group 11, a fixed angle of 60°.

The lasers 13 of the same group 11, 11a, 11b are preferably identical. The lasers 13 are preferably lasers operating in the near infrared, i.e. with a wavelength comprised between 1000 and 1100 nm.

The lasers 13 are e.g. fiber lasers.

The lasers 13 are preferably suitable for selectively emitting continuous or pulsed beams. Pulsed beams have a pulse duration e.g. on the order of nanosecond, microsecond or millisecond.

The lasers 13 comprise e.g. Nd:YAG lasers and/or YLS lasers.

Where the stripping assembly 7 comprises two groups 11a, 11b of lasers, the first group 11a of lasers is e.g. intended to strip the layer of oxide on the surface of the long product 3 by ablating at least part of a layer of metal of predetermined thickness on the surface of the long product 3, and the second group 11b of lasers is intended to finalize the ablation of the layer of metal of predetermined thickness while imparting the predetermined roughness to the surface of the long product 3.

In such case, the lasers of the first group 11a preferably operate in a mode different from the mode of the lasers of the second group 11b. Indeed, the lasers of the first group 11a are then configured so as to effectively strip the layer of oxide, and optionally partially adjust the roughness on the surface of the stripped wire, and the lasers of the second group 11b are configured so as to adjust the roughness at the surface of the stripped wire, while finishing the stripping, if appropriate.

For example, the lasers of the first group 11a are YLS lasers configured to operate in continuous mode, while the lasers of the second group 11b are Nd:YAG lasers configured to operate in pulsed mode, in particular with a pulse duration on the order of a nanosecond.

In a variant, the lasers of the first and second groups 11a, 11b are identical. As an example, the lasers of the first and second groups 11a, 11b are lasers operating in pulsed mode, in particular Nd:YAG lasers, or lasers operating in continuous mode, in particular YLS lasers. In such case, the lasers of the first group are preferably configured with operating parameters, e.g. in terms of intensity or of frequency, different from the parameters of the lasers of the second group.

The stripping assembly 7 preferably comprises a mechanical or optical distribution system enabling each laser 13 to cover the portion of the surface of the long product assigned to said laser.

More particularly, the distribution system is intended to shape the laser beams emitted by the lasers 13 of each group and/or move the laser beams across the surface of the long product 3 in such a way that the laser beams emitted by the lasers of each group cover the entire surface of the long product 3 during the movement thereof.

For example, in the case of a wire, the distribution system is configured in such a way that the angles βᵢ associated with the different lasers 13 of a group 11, 11a and 11b are such that the entire surface of the wire 3 is covered by the lasers, which implies that the sum of the angles βᵢ is greater than or equal to 360°.

In particular, the distribution system is intended to shape the laser beams emitted by the lasers of each group 11, 11a, 11b, and/or to generate a scan of the surface of the long product 3 by the laser beams, in such a way that the laser beams emitted by each laser cover the portion assigned to said laser.

The distribution system is e.g. an optical system 15 configured to shape the beams coming from each laser 13 in such a way that the beams, once same are shaped, cover the portion assigned to the laser 13.

Such a system comprises e.g. for each laser 13, an optical device 15 (FIG. 2) configured to transform the spots of the beams emitted by the laser 13 into strips orthogonal to the direction of movement of the long product 3. The strips are then of length equal to the width of the portion assigned to each laser (i.e. the distance between the two straight lines of the surface of the long product which delimit the portion).

The width of each strip, along the direction of movement, varies according to the speed of movement of the wire. Same is comprised between 20 μm and 200 μm, and typically on the order of 50 μm.

In this way, the entire surface of the long product 3 can be treated by a limited number of lasers 13.

Each optical device comprises e.g. lenses, spherical mirrors and/or cylindrical mirrors apt to adjust the shape and the dimensions of the laser beam.

In such embodiment, the lasers 13 are preferably lasers of high mean power or high pulse power, so as to maintain a sufficiently high energy density over the entire portion associated with each laser.

In a variant, the distribution system is an optical and mechanical scanning system.

Such a scanning system comprises e.g., for each laser 13, an optical and mechanical device suitable for shaping the beams generated by the laser 13 in order to concentrate the power thereof, and to move the beams thereby shaped over the surface of the long product 3 moving in such a way that the beams affect the entire portion assigned to the laser 13.

More particularly, the optical and mechanical is apt to move the beams generated by the laser 13 over the surface of the long product 3, so that each laser can affect he portion of the surface assigned to the laser.

For example, the optical and mechanical device is configured to move the beams along a first and a second direction of scanning orthogonal to each other, in particular along a plurality of successive parallel lines. The scanning is thereby performed, for each line, along the first direction, and, to move from one line to the next, along the second direction.

The first and second direction of scanning form an angle comprised between 0° and 90° with the axis of movement. For example, the directions are parallel and orthogonal, respectively, to the axis of movement, or orthogonal and parallel, respectively, to the axis of movement, or each form a non-zero angle, e.g. approximately 45°, with the axis of movement.

The optical and mechanical device is configured to generate such scan at a scan speed and a scan pitch adapted to the desired treatment, as described hereinafter.

For example, the beams coming from each laser 13 scan the portion associated with said laser along lines parallel to the first direction of scanning, the lines being shifted with respect to one another according to the scan pitch chosen.

Such an optical and mechanical system comprises e.g. at least one galvanometric mirror and may further contain a polygonal wheel.

Such embodiment does not require the use of lasers with as high power as in the case of the optical system 15, since the size of the impact of each beam generated by the laser is small.

Preferably, the stripping assembly 7 comprises an enclosure 17, inside which the group(s) 11, 11a, 11b of lasers 13 and the distribution system, are accommodated. Of course, the enclosure 17 comprises two openings on two opposite walls to enable the long product 3 to move through the enclosure 17. The enclosure 17 is made e.g. of stainless-steel.

The use of such an enclosure 17 protects the external elements as well as the operators from laser radiation.

Preferably, the walls of the enclosure 17 are equipped with active and/or passive safety systems for cutting off the lasers in the event of problems (e.g. in the event of overheating or puncture of the enclosure). For example, the enclosure has a double wall containing a fluid the pressure or level of which is measured continuously.

Furthermore, cameras are preferably installed inside the enclosure in order to monitor the smooth progress of the treatment.

The control unit 9 is intended to control the stripping assembly 7 in order to impose on thereto, operating parameters for obtaining the stripping of the entire layer of oxide over the entire surface of the long product 3, the ablation of a layer of metal on the surface of the long product 3, the layer of metal being of predetermined thickness, and in order to obtain a predetermined roughness on the surface of the long product 3 at the end of the treatment.

The control unit 9 comprises in particular, a memory, a calculator and a human/machine interface.

To this end, the control unit 9 is suitable for acquiring information relating to the long product 3 in movement.

Such information includes in particular the speed of movement of the long product 3 in the treatment facility 5. Knowledge of said speed is needed to adjust the operating parameters of the stripping assembly 7 so that each point on the surface of the wire is exposed to laser radiation for an adequate period of time.

Such information further comprises at least one characteristic dimension of the long product 3 in a plane transverse to the direction of movement of the long product 3. The dimension is e.g. for a wire, the diameter of the wire. If the long product is a ribbon, the characteristic dimensions are e.g. the width and the thickness of the ribbon. Such dimension or dimensions serve to know the extent of the surface to be treated, and to focus the laser radiation emitted by the stripping assembly 7 precisely on the surface to be treated.

Such information preferably includes a position of the axis of movement A_{d} in a plane orthogonal to said axis. Indeed, it may happen that the axis of movement A_{d} changes position in a plane orthogonal to the axis A_{d}, which may require modifying the focusing of the lasers 13 and/or the distribution of the laser beams in order to guarantee the desired surface state.

The information acquired by the control unit 9 is e.g. entered by an operator via the interface of the control unit 9, and recorded in the memory

In a variant or in addition, the treatment facility 5 is equipped with a system for determining, in particular for measuring the speed of movement of the long product 3 and/or a system for determining or measuring the position of the long product 3 within the stripping assembly 7, in particular the position of the axis of movement A_{d}. In such case, the information relating to the moving long product is supplied to the control unit in real time by the determination system(s).

The control unit 9 is also configured to acquire the desired treatment parameters for the long product 3 to be treated.

The treatment parameters include in particular a desired roughness for the long product 3 at the end of the treatment.

The treatment parameters preferably include parameters relating to the layer of oxide to be ablated and/or a thickness of the layer of metal to be ablated on the surface of the long product 3.

The treatment parameters are e.g. entered by an operator via the interface of the control unit 9, and recorded in the memory of the control unit 9, or else entered automatically according to the product to be treated.

In a variant, or in addition, at least some of the treatment parameters, more particularly the desired roughness for the long product 3 at the end of the treatment, are provided by the facility 6 which draws the wire, which makes it possible to adjust in real time the state of the surface of the wire, to facilitate the drawing of said wire.

The control unit 9 is configured to determine operating parameters to be imposed on the stripping assembly 7, more particularly on the lasers of the group or groups 11, 11a, 11b of lasers in order to obtain the stripping of the layer of oxide on the surface of the long product 3, to ablate the layer of metal of predetermined thickness on the surface of the long product, and to obtain the predetermined roughness on the surface of the long product 3. The thickness of the layer of metal and the predetermined roughness are parameters previously acquired by the control unit 9, as described hereinabove.

To this end, the control unit 9 is suitable for recording, in the memory, experimental reference data, enabling the computer to determine, according to the desired treatment parameters and information relating to the moving long product, the operating parameters to be imposed on the stripping assembly 7.

The operating parameters comprise e.g. the emission power of the lasers 13, an operating mode of the lasers 13 (continuous or pulsed beams), and the duration of laser/material interaction (corresponding to the duration during which a laser beam affects the surface of the product).

Indeed, whatever the speed of movement, each portion of the surface should have been treated and should have received an energy density requested and given by the control unit 9. The energy density will be a function of the laser/material interaction time and the power density of the laser beam.

For a laser in continuous mode, the laser/material interaction time, which depends on the speed of movement, depends on the settings of the distribution system. For example, if the distribution system includes, at least for certain lasers 13, an optical device 15, the laser/material interaction time is adjusted by varying the width of the strips formed by the optical device 15 from the laser spots.

If the distribution system includes, at least for certain 13 lasers, a scan system, the laser/material interaction time is adjusted by varying the scan speed and the scan pitch.

For a pulsed laser, as for a continuous laser, the laser/material interaction time, which depends on the speed of movement, depends on the settings of the distribution system. For example, if the distribution system includes, at least for certain lasers 13, an optical device 15, the laser/material interaction time is adjusted by varying the width of the strips formed by the optical device 15 from the laser spots. If the distribution system includes, at least for certain 13 lasers, a scan system, the laser/material interaction time is adjusted by varying the scan speed and the scan pitch.

For a pulsed laser, the laser/material interaction time is further adjusted by varying the pulse duration and frequency of the pulsed beams.

Thereby, the operating parameters include, as the case may be, the width of the strips formed by the optical device 15, the scan speed and pitch, and/or the pulse duration and frequency of the pulsed beams.

For example, the emission power of the lasers 13 is chosen to be as high as the speed of movement of the long product 3 is fast and/or the thickness of the layer of metal to be ablated is large.

Furthermore, the higher the running speed, the higher the frequency of the pulses, in order to ensure that a given portion is adequately treated by the laser 13 which relates to same.

Moreover, the scan speed is chosen to be as high as the speed of movement of the long product is fast.

In general, if the thickness of the layer of metal to be ablated is small, a high speed of movement will be chosen, thereby using a high scan speed.

The operating parameters are also, as described above, selected so as to obtain a surface of predetermined roughness.

The desired roughness is obtained e.g. by adapting the operating mode of the lasers 13, e.g. by selecting the pulsed mode, and by adapting the laser/material interaction time on the surface of the long product in such a way that the laser impacts generate, on the surface of the long product 3, craters with dimensions and spacing or overlap imparting the desired roughness to the surface.

When the distribution system is an optical and mechanical scanning system, the roughness is e.g. adjusted by selecting the scan pitch as a function of the width of the laser beam.

For example, if the width of the beam is 75 μm, the beams coming from each laser scan the portion along lines of width equal to 75 μm, forming grooves of said width. If the scan pitch is chosen to be less than or equal to 75 μm, in particular 25 μm, the scan of the portion will generate a surface with very low roughness. If, on the other hand, the scan pitch is chosen to be greater than the width of the beam, e.g. 100 μm, ridges will subsist between each groove, imparting a higher roughness to the surface of the product.

The operating parameters of the lasers of the same group 11, 11a, 11b are generally identical to each other. Such is more particularly the case if the portions of surface treated by the lasers 13 are of identical dimensions, the lasers being located at the same distance from the portion to be treated.

On the other hand, when the stripping assembly 7 comprises two or a plurality of groups, the operating parameters generally differ from one group to another.

In particular, since the stripping assembly 7 comprises two groups, the operating parameters of the lasers of the first group 11a are preferably selected so as to effectively strip the layer of oxide, whereas the operating parameters of the lasers of the second group 11b are selected so as to impart the desired roughness to the surface of the stripped long product.

For example, the lasers of the first group 11a are configured to operate in continuous mode, the power of the lasers being selected to strip the entire layer of oxide, and the lasers of the second group 11b are configured in pulsed mode, the pulse duration and, if appropriate, the scan pitch being chosen so that the impacts of the pulses generate the desired roughness on the surface of the long product 3.

The control unit 9 is apt to control the stripping assembly 7 according to the operating parameters thereby determined.

The control unit 9 is configured to determine the operating parameters before any stripping, and preferably during the treatment, more particularly following the detection of a change in one or a plurality of parameters relating to the moving long product or of the desired treatment parameters.

For example, if the speed of movement is determined continuously or at certain times by a system for determining the speed of movement, and supplied to the control unit 9, the control unit 9 is configured to determine new operating parameters in the event of a change in the speed of movement, and to apply the new operating parameters to the stripping assembly 7.

In addition, if the position of the axis of movement A_{d} is determined continuously or at certain times by a system for determining that position and supplied to the control unit 9, the control unit 9 is configured to determine new operating parameters in the event of a change in said position, and to apply the new operating parameters to the stripping assembly 7.

According to another example, if the long product is drawn directly at the outlet of the stripping assembly 7, and if the drawability thereof proves insufficient, the desired roughness can be modified to increase the drawability. The control unit 9 is configured to receive the new desired roughness, to determine new operating parameters suitable for obtaining the new roughness, and to apply the new operating parameters to the stripping assembly 7.

A method for treating a long product 3 according to one embodiment will now be described. The treatment method is preferably implemented by means of a treatment facility 5 as described hereinabove.

In the present example, a facility 5 will be considered wherein the stripping assembly 7 comprises two groups of lasers one after the other along the direction of movement of the product.

Moreover, it will be considered that the long product 3 is a wire, and that each group 11a, 11b of lasers comprises six lasers 13 uniformly distributed around the wire 3, and located on the circumference of a circle the center of which is occupied by the center of the wire 3.

Each laser 13 of each group 11a, 11b is thereby intended to treat a portion of the surface of the wire extending between two straight lines parallel to the axis of movement A_{d} of the wire 3 and defining with the axis an angle β of at least 60°.

The treatment method is e.g. implemented after an annealing treatment carried out on the long product 3 in the form of a crown.

The treatment method is carried out on the moving long product 3, following the unwinding thereof.

The method comprises a step of acquisition, by the control unit 9, of parameters or information relating to the moving long product and of desired treatment parameters.

As described hereinabove, the parameters relating to the moving long product comprise the nature of the long product 3 (e.g. wire or ribbon), the speed of movement of the long product 3 in the treatment facility 5 and/or a characteristic dimension of the long product 3 in a plane transverse to the direction of movement of the long product 3. Such information is e.g. entered by an operator via the interface of the control unit 9, or entered automatically when the long product 3 is loaded into the facility, and recorded in the memory.

In a variant or in addition, the information relating to the moving long product is determined by a system for detecting the speed of movement of the long product 3 and/or a system for detecting the position of the long product 3 within the stripping assembly.

The desired treatment parameters for the long product 3 include the desired roughness for the long product 3 at the end of the treatment, and preferably parameters relating to the layer of oxide to be ablated and/or a thickness of the layer of metal to be ablated on the surface of the long product 3.

The treatment parameters are e.g. entered by an operator via the interface of the control unit 9, and recorded in the memory of the control unit 9.

The method then comprises a step of determining, by the control unit 9, operating parameters to be imposed on the lasers of the group or groups 11, 11a, 11b of lasers in order to obtain the etching of the layer of oxide on the surface of the long product 3, to ablate the layer of metal of predetermined thickness on the surface of the long product, and to obtain the predetermined roughness on the surface of the long product 3.

Such operating parameters are determined from experimental reference data recorded in the memory of the control unit 9.

The operating parameters include e.g. the emission power of the lasers 13, the mode of operation of the lasers 13 (continuous or pulsed beams), and, where appropriate, the pulse duration and the pulse frequency of the pulsed beams.

If the distribution system is an optical and mechanical scanning system, the operating parameters comprise, for each laser 13, scanning parameters of the portion assigned to the laser 13 by said laser, in particular the scan speed and the scan pitch.

The control unit 9 then transmits the operating parameters thereby determined, to the stripping assembly 7.

The stripping assembly 7 then treats the surface of the long product 3 according to the operating parameters.

More particularly, each laser 13 emits laser beams in the chosen operating mode, and with the power controlled by the control unit 9.

If the operating mode of the lasers 13 of at least one group 11, 11a, 11b is the pulsed mode, each laser 13 emits laser pulses the duration and frequency of which are same controlled by the control unit 9.

Moreover, if the laser distribution system 13 of at least one of the groups 11, 11a, 11b is a scanning system, the scanning system generates a scan of the laser beams emitted by each laser according to the scan speed and the scan pitch controlled by the control unit 9.

During the movement long product 3 through the stripping assembly 7, each laser 13 of each group 11, 11a, 11b emits laser beams to treat the portion of surface of the product assigned thereto, according to the operating parameters imposed by the control unit 9.

Since the long product 3 is in movement, the portion treated by each laser 13 at the end of the treatment extends over the entire length of the long product 3 in the direction of movement (different successive sections of each portion moving in front of the stripping assembly).

If the stripping assembly comprises a first group of first lasers and a second group of second lasers, the surface is treated successively by the lasers of the first group and then by the lasers of the second group.

According to one embodiment, each group 11 of lasers treats the entire surface of the long product. In such embodiment, the entire surface of the long product is treated successively by the lasers of the first group 11a, then by the lasers of the second group 11b, and where appropriate, by the lasers of each additional group.

In a variant, at least one group 11 of lasers treats only a part of the surface of the long product. In such variant, the groups 11 of lasers, taken together, treat the entire surface of the long product.

At the end of the treatment, the long product 3 is devoid of oxides on the surface thereof. In particular, the long product 3 is devoid of oxides resulting from the residence of the product at high temperature in an oxidizing atmosphere (in particular during annealing).

Furthermore, the long product 3 has a characteristic roughness profile different from same obtained by chemical stripping.

Roughness profile refers to the profile derived from the primary profile by suppressing elongate wavelength components, by applying a filter of profile λc to suppress wavelength components greater than λc (in particular ripple components), as described in the standard NF EN ISO 4287:1998. In the present case, wavelength components smaller than λc=2.5 mm, are considered.

More particularly, following stripping in a bath, the long product has a granular surface and has irregular and non-periodic patterns on the surface thereof.

On the other hand, the surface of the long product 3 treated according to the invention has a periodic roughness profile, i.e. has periodic roughness patterns on the surface thereof.

The roughness patterns form profile elements on the roughness profile (as defined in the standard NF EN ISO 4287:1998).

As specified in NF EN ISO 4287:1998, the roughness profile is determined from a surface profile resulting from the intersection of the real surface with a given cutting plane, a normal of which is parallel to the real surface and has an appropriate direction.

The width of the periodic patterns is comprises 5 μm and 1 mm, and comprised e.g. between 5 μm and 200 μm.

For example, the patterns are periodic striations, comprising a regular alternation of protruding lines (or ridges) and grooves.

The grooves correspond to the zones of the surface of the long product 3 that have received the highest energy density of the lasers 13, whereas the protruding lines are the zones of the surface of the long product 3 that have received the lowest energy density of the lasers 13.

The grooves and lines extend e.g. along a direction parallel to the central axis of the long product 3, along a direction orthogonal to the central axis of the long product 3, or along a direction oblique to the central axis of the long product (in particular forming an angle of 45° with the central axis).

For example, if the distribution system is an optical and mechanical scanning system, the orientation direction of the lines and grooves corresponds to the direction of scanning of the laser beams (i.e. the first direction of scanning defined hereinabove). The distance between grooves (i.e. in the second direction of scanning) is then equal to the scan pitch.

Referring to the above example, if the beam width is 75 μm and the scan pitch is equal to 100 μm, the grooves will have a width of about 75 μm whereas the projecting lines (or ridges) will have a width of about 25 μm.

In general, the distance between grooves (corresponding to the width of the periodic patterns) is comprised between 5 μm and 1 mm, and comprised e.g. between 5 μm and 200 μm. Of course, distance between grooves refers the distance between each groove and an adjacent groove.

In a variant, the periodic patterns are formed by a regular alternation of peaks and recesses along a first and a second distinct direction.

The first and second directions are e.g. orthogonal to each other, in particular parallel to the central axis of the long product 3 and orthogonal to the central axis, respectively.

According to another example, at least one of the first and second directions is neither parallel nor orthogonal to the central axis of the long product 3. In all cases, the periodic patterns are seen, on the roughness profile, in the form of periodic profile elements, each consisting of a peak and a recess.

The height of the profile elements, e.g. the mean height between the ridges and the grooves, or the mean height between the peaks and the recesses, is generally comprised between 0.2 μm and 500 μm.

In order to measure the distance between the profile elements and the height thereof, as explained hereinabove, an appropriate cutting plane is chosen, e.g. by first viewing the surface of the product by imaging, in particular by optical microscopy, scanning electron microscopy, or by means of a roughness meter.

For example, if the periodic patterns are grooves and protruding lines parallel to the central axis of the long product 3, a cutting plane orthogonal to the central axis will be chosen. On the other hand, if the lines and grooves are orthogonal to the central axis of the long product 3, a cutting plane parallel to the central axis will be chosen.

If the periodic patterns are alternations of peaks and recesses along a first and a second direction, it is preferable to choose two cutting planes parallel to the first and second directions, respectively, and the mean width and height in each of the directions will be evaluated.

Preferably, the waste generated by the stripping of the oxide and the removal of metal by the stripping assembly 7 is recovered by dust and smoke extraction systems.

Preferably, during the treatment, the operating parameters are recalculated by the control unit 9 in the event of modification of parameters relating to the long product in movement, or of the desired treatment parameters.

For example, if the speed of movement is determined continuously or at certain times by a system for determining the speed of movement and supplied to the control unit 9, a change in the speed of movement leads to the calculation of new operating parameters, suitable for the new speed of movement, and the new operating parameters are applied to the stripping assembly 7.

Furthermore, if the position of the axis of movement A_{d} is determined continuously or at certain times by a system for determining said position and supplied to the control unit 9, the control unit 9 determines new operating parameters in the event of a change in the position, and applies the new operating parameters to the stripping assembly 7.

According to another example, if the long product is drawn directly at the outlet of the stripping assembly 7, and if the drawability thereof proves insufficient, the desired roughness can be modified to increase the drawability. The new roughness is supplied to the control unit 9, leading to a calculation of new operating parameters suitable for obtaining the new roughness, and the new operating parameters are applied to the stripping assembly 7.

According to yet another example, in the event of a malfunction of a laser or lasers in a group, the operating parameters can be recalculated to take into account such malfunction.

The facility and the method according to the invention thus serve to treat efficiently, quickly and without the use of harmful products, ensuring both the stripping of the layer of oxide present on the long product, removing surface defects, internal oxides, inclusions and/or zones of different chemical composition from the composition of the core of the metal on the surface of the metal under the layer of oxide, and imparting to the surface of the long product a roughness making same apt to be drawn without any additional operation.

Although the facility and the method have been described more particularly with reference to a wire, the facility and method are also suitable for the treatment of other types of long products such as ribbons.

For example, to treat a ribbon comprising two main surfaces and two surfaces extending along the thickness of the ribbon, one group or groups of lasers comprising at least one laser arranged opposite each main surface, may be used, and at least one laser placed opposite each of the surfaces extending along the thickness of the ribbon.

1. A facility for treating of a metal long product in movement, in preparation for a wire drawing step, the long product having at least one surface covered with a layer of oxides, comprising:
a stripping assembly comprising at least one group of a plurality of lasers distributed around the moving long product each laser being configured to emit beams onto the surface of the moving long product for stripping the surface, each laser being intended for the treatment of an associated portion of the surface of the long product
a control unit configured to acquire information relating to the long product in movement, the information comprising a speed of movement of the long product and at least one characteristic dimension of the long product in a plane orthogonal to an axis of movement of the long product,
the control unit being configured to:
determine operating parameters to be imposed on the stripping assembly for obtaining the stripping of the layer of oxides on the surface of the long product and to ablate a layer of metal of predetermined thickness on the surface of the long product and so as to obtain a predetermined roughness on the surface of the long product compared with experimental results pre-recorded in the control unit and
impose said operating parameters to said stripping assembly.

2. The treatment facility according to claim 1, wherein the lasers of the or each laser group are uniformly distributed around the moving long product.

3. The treatment facility according to claim 1, wherein the operating parameters include an emission power of the lasers of the or each group and/or a laser/material interaction time at each point on the surface of the long product.

4. The treatment facility according to claim 1, wherein the stripping assembly comprises a distribution system configured to shape the laser beams or to move the laser beams across the surface of the long product such that the laser beams emitted by the plurality of lasers in the or each group cover the entire surface of the long product during the movement thereof.

5. The treatment facility according to claim 4, wherein the distribution system comprises, for each laser of at least one group, an optical device configured to transform each beam emitted by the associated laser into a band affecting a portion of the surface of the long product.

6. The treatment facility according to claim 4, wherein the distribution system comprises, for each laser in at least one group, a scanning device configured to move the beams generated by the associated laser across the surface of the long product, according to a predetermined scan speed and scan pitch, so that the beams emitted by each laser affect a portion of surface of the long product.

7. The treatment facility according to claim 6, wherein the operating parameters comprise the scan speed and the scan pitch of the scanning device.

8. A treatment facility according to claim 5, wherein the portion of surface of the long product is defined by two straight lines, parallel to each other, of the surface of the long product.

9. The treatment facility according to claim 1, wherein the stripping assembly comprises a first group of a plurality of first lasers distributed around the moving long product and a second group of a plurality of second lasers distributed around the moving long product each second laser being downstream of each first laser of the first group with respect to the axis of movement.

10. The treatment facility according to claim 9, wherein the first lasers are configured to strip the layer of oxides on the surface of the long product by ablating a layer of metal of predetermined thickness on the surface of the long product and the second lasers are configured to impart the predetermined roughness to the surface of the long product.

11. The treatment facility according to claim 9, wherein the first lasers are continuous emission lasers, and the second lasers are continuous emission lasers or lasers configured to emit pulsed beams, in particular nanosecond lasers.

12. A treatment method, by means of a facility according to claim 1, for a moving metal long product in preparation for a wire drawing step, the long product having at least one surface covered with a layer of oxides, comprising the following steps:
acquisition by the control unit of information relating to the long product in movement, the information comprising a speed of movement of the long product and at least one characteristic dimension of the long product in a plane transverse to an axis of movement of the long product
determination by the control unit according to the information relating to the long product in movement, of the operating parameters to be imposed on the stripping assembly for obtaining the stripping of the layer of oxides on the surface of the long product and to ablate a layer of metal of predetermined thickness on the surface of the long product and so as to obtain a predetermined roughness on the surface of the long product by comparison with experimental results pre-recorded in the control unit
control by the control unit of the stripping assembly to impose said operating parameters on the stripping assembly
emission by the stripping assembly by means of lasers, of laser beams on the surface of the moving long product according to the operating parameters determined by the control unit.

13. A metal long product for wire drawing, the long product having periodic roughness patterns on the surface thereof, a width of the periodic patterns being comprised between 5 μm and 1 mm.

14. The metal long product according to claim 13, wherein the width of the periodic patterns is comprised between 5 μm and 200 μm.

15. A metal long product according to claim 13, wherein the periodic patterns consist of periodic striations, comprising a regular alternation of protruding ridges and grooves, or in patterns comprising a regular alternation of peaks and recesses along a first and a second distinct directions.

16. The metal long product according to claim 15, wherein the average height between the ridges and grooves, or the average height between the peaks and recesses, is comprised between 0.2 μm and 500 μm.

17. The long product according to claim 13, wherein the long product is a wire or a ribbon.

18. The metal long product according to claim 13, wherein the long product is apt to be drawn without undergoing a surface preparation treatment by chemical or mechanical stripping.
